(19) United States
(12) Patent Application Publication
(10) Pub. No.: US 2026/0135604 A1
(43) Pub. Date: May 14, 2026

(54) SOUNDING REFERENCE SIGNAL PANEL SWITCHING FOR UPLINK BEAM MANAGEMENT

(71) Applicant: Telefonaktiebolaget LM Ericsson (publ), Stockholm (SE)

(72) Inventors: Andreas NILSSON, Göteborg (SE); Sven JACOBSSON, Västra Frölunda (SE); Fredrik ATHLEY, Västra Frölunda (SE)

(73) Assignee: Telefonaktiebolaget LM Ericsson (publ), Stockholm (SE)

(21) Appl. No.: 19/114,658

(22) PCT Filed: Sep. 28, 2022
(86) PCT No.: PCT/EP2022/076975

§ 371 Date: Mar. 24, 2025

(51) Int. Cl. H04B 7/06; H04L 5/00

(52) U.S. Cl. CPC H04B 7/06952; H04L 5/005

(57) ABSTRACT

A method in a wireless device (120) for facilitating the determination of a beam to be used for communication with a network, the method comprising: indicating to the network a capability to transmit from different panels (126), each panel representing a group of related transmit antennas: receiving from the network an uplink reference signal. UL RS, configuration indicating at least two UL RS resources to be transmitted from different panels: transmitting a plurality of UL RSs using the different panels in accordance with the UL RS configuration; and receiving an instruction to communicate with the network using one or more beams, each beam corresponding to one of the transmitted UL RSs.

### TECHNICAL FIELD

The present disclosure relates to the field of cellular communication between multiantenna transceivers. In particular, it proposes a technique for determining a beam suitable for communication between a network node and a wireless device equipped with multiple antenna panels.

### BACKGROUND

In high frequency range, denoted FR2 in 3GPP NR, multiple radio-frequency (RF) beams may be used to transmit and receive signals at a gNB and a user equipment (UE). For each downlink (DL) transmit (Tx) beam from a gNB, there is typically an associated best UE receive (Rx) beam for receiving signals from the DL beam. The DL Tx beam and the associated UE Rx beam form a beam pair; the DL beam and the associated UE Rx beam may be imagined to be connected by a conceptual beam pair link. The beam pair can be identified through a so-called beam management process in NR.

In deployments with multiple transmission points (TRP) or distributed multiple-input multiple-output (D-MIMO) millimeter-wave (mmWave) communication, it may be beneficial to use sounding reference signal (SRS) based beam management procedures—and uplink (UL) beam management procedures in particular—to determine suitable beam pair links between the network and the UE instead of using DL beam management procedures. Indeed, for multi-TRP or D-MIMO mmWave deployments, the beam management overhead for DL beam management procedure will be very high, since for each UE there are multiple different beams from multiple different TRPs or access points (APs) that need to be evaluated frequently.

A further level of difficulty is introduced if the UE has multiple panels, a panel being a group of related transmit antennas. More precisely, since signals can arrive at a UE and emanate from it in all different directions, it is beneficial to have an antenna implementation at the UE with the ability to generate omni-directional-like coverage in addition to the high-gain narrow beams. One way to increase the omni-directional coverage at a UE is to install multiple panels with mutually different orientations, as illustrated in FIG. 4. Many commercially available UEs already have multiple panels at their disposal.

For UEs served by multi-TRP or D-MIMO mmWave deployments, it would seem a promising prospect to use UL beam management procedures, whereby it will be possible to determine a suitable beam pair link between any of the TRPs/APs and a UE in an overhead-efficient way. However, the current UL beam management procedures in 3GPP NR lack in preciseness, and they are therefore difficult to apply in a meaningful way. To illustrate, it is assumed that the network is going to determine a suitable UE beam from a UE with multiple transmit antenna panels, and that the network configures an SRS resource set with the indicated usage Beam Management. The UE receiving this configuration will most likely select a number of beams to evaluate from a single one of the UE panels. Currently, the network has no way of ensuring that the UE perform a beam management procedure over multiple different UE panels. Since the optimal beam pair link might differ depending on which UE panel that is used during the UL beam management procedure, there is a considerable a large risk of selecting a sub-optimal beam pair link when using current NR UL beam management procedures.

Similarly, if the network wishes to evaluate beam pair links to a UE from several different APs/TRPs, there may be insufficient data for a well-informed evaluation if the UE sounds only beams associated with one of the UE panels, since the different APs/TRPs might located in many different directions with respect to the UE. Hence, the current NR UL beam management procedures are not well suited for multi-TRP and D-MIMO deployments, and updates to the UL beam management procedure are likely needed in coming releases of 3GPP NR and future 6G.

Beam prediction based on machine learning (ML) or artificial intelligence (AI) is a promising and busy area of development, including an ongoing study item within 3GPP NR Release 18. To facilitate the AI/ML-based beam prediction, it is generally beneficial to accumulate as much information as possible-and as diverse information as possible—at the gNB. This includes information used for initially training the AI/ML model as well as information to be fed during operation to the trained model to obtain a decision. The current NR DL beam management procedures are of limited use for AI/ML based beam prediction, due to several uncertainties in the UE beam reporting. Indeed, the beam reporting is to a large extent dependent on UE implementation, e.g., which UE panel to use, which UE beam (e.g., wide, narrow) to use for the selected UE panel, how long the performance metric reported in the beam report shall be filtered in time etc., and thus out of the network's control. For similar reasons, the current NR UL beam management procedures are not very useful for AI/ML based beam prediction either, due to uncertainties about which panel the UE is using, which beams the UE is using for the selected UE panel etc. Accordingly, the need to improve the current NR UL beam management procedures is further underlined by the desire to provide more information at the gNB to facilitate AI/ML-based beam prediction.

### SUMMARY

One objective of the present disclosure is to make available an improved way of determining a beam to be used for communication between a network node and a UE with multiple panels. A further objective is to leverage the transmission abilities of the multi-panel UE more completely, to achieve better-performing communication. In particular, this may include enabling communication using a globally optimal beam, rather than just the best beam transmissible from one of the UE's panels. A further objective is to propose pre-agreed signaling which allows the network control of panel switching and/or panel selection at the UE. A still further objective is to facilitate the use of ML-based beam prediction, including by providing more diverse and/or more complete data for training and decision-making.

At least some of these objectives are achieved by the invention as defined by the independent claims. The dependent claims relate to advantageous embodiments of the invention.

In a first aspect of the present disclosure, there is provided a method to be performed by a wireless device for facilitating the determination of a beam to be used for communication with a network. The method comprises: receiving an uplink reference signal, UL RS, configuration from the network, the UL RS configuration indicating at least two UL RS resources to be transmitted from different panels, each panel representing a group of related transmit antennas; transmitting a plurality of UL RSs using the different panels in accordance with the UL RS configuration; and receiving an instruction to communicate with the network using one or more beams, each beam corresponding to one of the transmitted UL RSs.

In a second aspect, there is provided a wireless device (or UE) suitable for facilitating the determination of a beam to be used for communication with a network. The wireless device has processing circuitry configured to execute the method of the first aspect.

In a third aspect of the present disclosure, there is provided a method to be performed by a network node for determining a beam to be used for communication with a wireless device. The method comprises: transmitting an uplink reference signal, UL RS, configuration to the wireless device, the UL RS configuration indicating at least two UL RS resources to be transmitted from different panels, and each panel representing a group of related transmit antennas; receiving a plurality of UL RSs from the wireless device in accordance with the UL RS configuration; selecting one or more of the received UL RSs; and transmitting an instruction for the wireless device to communicate with the network using beams corresponding to the selected one or more UL RSs.

In a fourth aspect, there is provided a network node (e.g., base station, such as a gNB) suitable for determining a beam to be used for communication with a wireless device. The network node has processing circuitry configured to execute the method of the third aspect.

In a fifth aspect, there is provided a computer program containing instructions for causing a computer—or processing circuitry within the wireless device or network node in particular—to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

The first, second, third, fourth and fifth aspects can be used to introduce a panel switching scheme, which may be adopted as part of a pre-agreed protocol, and especially of a protocol within a telecommunication standard. This simplifies the network's task of determining suitable beam pair links for a UE based on UL beam management procedures. Optionally, the beam pair link selection may also include selection of a suitable AP/TRP and UE panel. This will enhance the performance at mmWave frequencies for a number of different deployments, such as D-MIMO deployments, multi-TRP deployments, mmWave base stations, networks with AI/ML-based beam prediction and deployments with ‘uplink-only’ nodes.

In some embodiments, the wireless device initially indicates a capability to transmit from different panels. In particular, the UE may indicate a capability to transmit, during a beam management procedure, on different UL RS resources which are associated with (or transmitted from) at least two different UE panels. The network node may utilize the knowledge of this capability when it determines the UL RS configuration to be transmitted to the wireless device. In other words, the network does not need to rely on conservative assumptions about the UE is able to optimize the UL RS configuration in accordance with the true structural and functional characteristics of the UE. Thereby, a more complete range of beam combinations can be sounded and potentially used for the communication.

In a first subgroup of embodiments, common to all aspects of the present disclosure, the panels of the wireless device are not associated with an explicit panel ID.

In a second subgroup of embodiments, common to the first and second aspects, an explicit panel ID is associated with each of those panels of the wireless device that are in use.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, on which:

FIG. 1 shows a wireless device in the coverage area of one single-TRP base station and one multi-TRP base station;

FIG. 2 illustrates three example beam management procedures;

FIG. 3 illustrates uplink beam management;

FIG. 4 is a perspective view of a wireless device (UE) with four panels;

FIG. 5 is a schematic drawing of a wireless device with three panels oriented in orthogonal directions to improve coverage, wherein the wireless device has one baseband chain at its disposal that can be connected to one of the panels at a time;

FIG. 6 depicts an example use case of the present disclosure, namely, a communication setup including a wireless device with three panels which operates in a multi-TRP/D-MIMO mmWave deployment; and

FIG. 7 is a sequence diagram illustrating a method of determining a beam to be used for communication between a network node and a wireless device.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

In general terms, the present disclosure proposes a signaling framework and capability reporting that supports a panel switching scheme in 5G/6G such that the network can configure a UE to transmit SRSs from all candidate UE panels using beams that cover the whole angular interval of the UE panel.

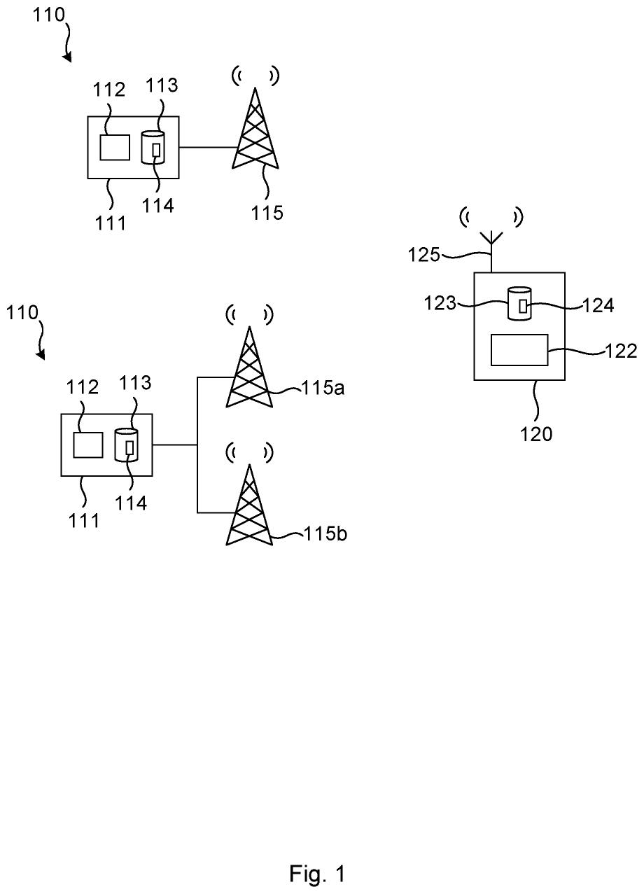

FIG. 1 relates to a first deployment where a wireless device 120 is located in the coverage area of one base station 110 with a single TRP 115 (upper portion of FIG. 1), and one base station 110 with two TRPs 115a, 115b (lower portion of FIG. 1). The base stations 110 are configured as network nodes in a radio access network within a cellular telecommunication system, such as a 3GPP NR system.

The figure schematically illustrates, in terms of a number of functional units, the components of the wireless device 120 according to an embodiment. Processing circuitry 122 is provided using any combination of one or more of a suitable central processing unit (CPU), multiprocessor, microcontroller, digital signal processor (DSP), etc., capable of executing software instructions stored in a computer program product 124, e.g. in the form of a storage medium 123. The processing circuitry 122 may further be provided as at least one application specific integrated circuit (ASIC), or field programmable gate array (FPGA). Particularly, the processing circuitry 122 is configured to cause the wireless device 120 to perform a set of operations, or steps, as disclosed below with reference to FIG. 7. For example, the storage medium 123 may store the set of operations, and the processing circuitry 122 may be configured to retrieve the set of operations from the storage medium 123 to cause the wireless device 120 to perform the set of operations. The set of operations may be provided as a set of executable instructions. Thus the processing circuitry 122 is arranged to execute the method for facilitating the determination of a beam to be used when the wireless device 120 communicates with the network node 110, to be described with reference to FIG. 7. The storage medium 123 may also comprise persistent storage, which, for example, can be any single one or combination of magnetic memory, optical memory, solid state memory or even remotely mounted memory.

The wireless device 120 may further comprise a communications interface 125 for communications with the network nodes 110. As such, the communications interface 125 may comprise one or more transmitters and receivers, comprising analogue and digital components. The processing circuitry 122 controls the general operation of the wireless device 120, e.g. by sending data and control signals to the communications interface 125 and the storage medium 123, by receiving data and reports from the communications interface 125, and by retrieving data and instructions from the storage medium 123. Other components, as well as the related functionality, of the wireless device 120 are omitted in order not to obscure the concepts presented herein.

FIG. 1 further illustrates, in terms of a number of functional units, the components of the network nodes 110 according to an embodiment. Each network node 110 comprises a frontend unit 111 and a TRP 115. The frontend unit 111 may be co-located with the TRP 115 or located remotely from this. In the frontend unit 111, processing circuitry 112 is provided using any combination of one or more of a suitable CPU, multiprocessor, microcontroller, DSP, etc., capable of executing software instructions stored in a computer program product 114, e.g. in the form of a storage medium 113. The processing circuitry 112 may further be provided as at least one ASIC or FPGA. Particularly, the processing circuitry 112 is configured to cause each network node 110 to perform a set of operations, or steps, as disclosed below with reference to FIG. 7. For example, the storage medium 113 may store the set of operations, and the processing circuitry 112 may be configured to retrieve the set of operations from the storage medium 113 to cause the wireless device 110 to perform the set of operations. The set of operations may be provided as a set of executable instructions. Thus the processing circuitry 112 is arranged to execute the method for determining a beam to be used when the network node 110 communicates with the wireless device 120, to be described with reference to FIG. 7. The storage medium 113 may also comprise persistent storage, as exemplified above.

The network node 110 may further comprise a communications interface including the TRP 115 for communications with the wireless device 120. As such, the communications interface may comprise one or more transmitters and receivers, comprising analogue and digital components. The processing circuitry 112 controls the general operation of the network node 110, e.g. by sending data and control signals to the communications interface (with the TRP 115) and the storage medium 113, by receiving data and reports from the communications interface, and by retrieving data and instructions from the storage medium 113. Other components, as well as the related functionality, of the network nodes 110 are omitted in order not to obscure the concepts presented herein.

### SRS

Before describing the inventors' contributions, some background concepts will be reviewed. In 3GPP NR, sounding reference signal (SRS) is used for providing a channel state indication (CSI) to the gNB in the UL. The usage of SRS includes, e.g., deriving the appropriate transmission/reception beams and/or performing link adaptation (i.e., setting the transmission rank and the MCS). SRS may further be used for selecting DL (e.g., for PDSCH transmissions) and UL (e.g., for PUSCH transmissions) MIMO precoding.

In LTE and NR, the SRS is configured via the Radio Resource Control (RRC) protocol, where parts of the configuration can be updated (for reduced latency) through MAC-CE signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the UE but instead a dynamic activation trigger is transmitted from the gNB in the DL, via the DCI in the PDCCH which instructs the UE to transmit the SRS once, at a predetermined time.

When configuring SRS transmissions, the gNB configures, through the SRS-Config IE, a set of SRS resources and a set of SRS resource sets, where each SRS resource set contains one or more SRS resources.

### SRS Configuration

Each SRS resource is configured with the SRS-Resource IE in RRC. See ASN code in 3GPP TS 38.331 version 16.1.0, clause 6.3.2.

This version of the RRC protocol allows an SRS resource to be configured with respect to one or more of the following:
The number of SRS ports (1, 2, or 4), configured by the RRC parameter nrofSRS-Ports.
The transmission comb (i.e., mapping to every 2nd or 4th subcarrier), configured by the RRC parameter transmissionComb, which includes:
   The comb offset, configured by the RRC parameter combOffset, is specified (i.e., which of the combs should be used).
   The cyclic shift, configured by the RRC parameter cyclicShift, that configures a (port-specific, for multi-port SRS resources) cyclic shift for the Zadoff-Chu sequence that is used for SRS. The use of cyclic shifts increases the number of SRS resources that can be mapped to a comb (as SRS sequences are designed to be (almost) orthogonal under cyclic shifts), but there is a limit on how many cyclic shifts that can be used (8 for comb 2 and 12 for comb 4).
The time-domain position within a given slot, configured with the RRC parameter resourceMapping, which includes:
   The time-domain start position, which is limited to be one of the last 6 symbols (in NR Rel-15) or in any of the 14 symbols in a slot (in NR Rel-16), configured by the RRC parameter startPosition.
   The number of symbols for the SRS resource (that can be set to 1, 2 or 4), configured by the RRC parameter nrofSymbols.
   The repetition factor (that can be set to 1, 2 or 4), configured by the RRC parameter repetitionFactor. When the repetition factor is larger than 1, the same frequency resources are used multiple times across symbols, used to improve the coverage as this allows more energy to be collected by the receiver.
The sounding bandwidth, frequency-domain position and shift, and frequency-hopping pattern of an SRS resource (i.e., which part of the transmission bandwidth that is occupied by the SRS resource) is set through the RRC parameters freqDomainPosition, freqDomainShift, and the freqHopping parameters c-SRS, b-SRS, and b-hop. The smallest possible sounding bandwidth is 4 RBs.
The RRC parameter resourceType determines whether the SRS resource is transmitted as periodic, aperiodic (singe transmission triggered by DCI), or semi persistent (same as periodic except for the start and stop of the periodic transmission is controlled through MAC-CE signaling instead of RRC signaling).
The RRC parameter sequenceld specifies how the SRS sequence is initialized.
The RRC parameter spatialRelationInfo configures the spatial relation for the SRS beam with respect to another RS (which could be another SRS, an SSB or a CSI-RS). If an SRS resource has a spatial relation to another SRS resource, then this SRS resource should be transmitted with the same beam (i.e., virtualization) as the indicated SRS resource.

In 3GPP NR Release 16, the additional (and optional) RRC parameter resourceMapping-r16 was introduced. If resourceMapping-r16 is signaled, the UE shall ignore the RRC parameter resourceMapping. The difference between resourceMapping-r16 and resourceMapping is that the SRS resource (for which the number of OFDM symbols and the repetition factor is still limited to 4) can start in any of the 14 OFDM symbols in a slot configured by the RRC parameter startPosition-r16.

Further, an SRS resource set is configured with the SRS-ResourceSet IE in RRC. See ASN code in 3GPP TS 38.331 version 16.1.0, clause 6.3.2.

SRS resource(s) will be transmitted as part of an SRS resource set, where all SRS resources in the same SRS resource set must share the same resource type. An SRS resource set is configurable with respect to one or more of the following:
For aperiodic SRS, the slot offset is configured by the RRC parameter slotOffset and sets the delay from the PDCCH trigger reception to the start of the SRS transmission.
The resource usage, which is configured by the RRC parameter usage sets constraints and assumptions on the resource properties (see 3GPP TS 38.214 for further details). SRS resource sets can be configured with one of four different usages (‘antennaSwitching’, ‘codebook’, ‘nonCodebook’ and ‘beamManagement’), which is assigned to the parameter ‘usage’.
   An SRS resource set that is configured with usage ‘antennaSwitching’ is used for reciprocity-based DL precoding (i.e., used to sound the channel in the UL so that the gNB can use reciprocity to set a suitable DL precoders). The UE is expected to transmit one SRS port per UE antenna port.
   An SRS resource set that is configured with usage ‘codebook’ is used for codebook-based UL transmission (i.e., used to sound the different UE antennas and help the gNB to determine/signal a suitable UL precoder, transmission rank, and MCS for PUSCH transmission). There are up to two SRS resources in an SRS resource set with usage ‘codebook’. How SRS ports are mapped to UE antenna ports is, however, up to UE implementation and not known to the gNB.
   An SRS resource set that is configured with usage ‘nonCodebook’ is used for NCB-based UL transmission. Specifically, the UE transmits one SRS resource per candidate beam (suitable candidate beams are determined by the UE based on CSI-RS measurements in the DL and, hence, reciprocity needs to hold). The gNB can then, by indicating a subset of these SRS resources, determine which UL beam(s) the UE should apply for PUSCH transmission. One UL layer will be transmitted per indicated SRS resource. Note that how the UE maps SRS ports to antenna ports is up to UE implementation and not known to the gNB.
   An SRS resource set that is configured with usage ‘beamManagement’ is used (mainly for frequency bands above 6 GHZ, i.e., for FR2) to evaluate different UE beams for analog beamforming arrays. The UE transmits one SRS resource per analog beam, and the gNB will perform an RSRP measurement per transmitted SRS resource and, in this way, determine a suitable UE beam that is reported to the UE.
The associated CSI-RS (this configuration is only applicable for NCB-based UL transmission) for each of the possible resource types.
   For an aperiodic SRS, the associated CSI-RS resource is set by the RRC parameter csi-RS.
   For semi-persistent/periodic SRS, the associated CSI-RS resource is set by the RRC parameter associatedCSI-RS.
The PC parameters, e.g., alpha and p0 (p-zero) are used for setting the SRS transmission power. SRS has its own UL PC scheme in NR (see 3GPP TS 38.213 for further details), which specifies how the UE should split the available output power between two or more SRS ports during one SRS transmit occasion (an SRS transmit occasion is a time window within a slot where SRS transmission is performed).

To summarize, the SRS-ResourceSet configuration can be used to determine, inter alia, the usage, power control, and slot offset for aperiodic SRS. The SRS resource configuration determines the time-and-frequency allocation, the periodicity and offset, the sequence, and the spatial-relation information.

### SRS Antenna Switching

It is desirable for the gNB to sound all UE antennas, wherein sounding an antenna means transmitting an SRS from that antenna, which, in turn, enables the gNB to estimate the channel between said UE antenna and the antennas at the gNB. Since however it is generally costly to equip the UE with many transmit ports, SRS antenna switching was introduced in 3GPP NR Release 15, for several different UE architectures for which the number of receive chains is larger than the number of transmit chains. If a UE supports antenna switching, it will report so by means of UE-capability signaling.

As specified in 3GPP TS 38.306, a Release-15 UE can report the following antenna-switching capabilities using the IE supportedSRS-TxPortSwitch:
t1r2,
t1r4,
t2r4,
t2r2,
t4r4,
t1r4-t2r4.
   For example, if a UE reports t1r2 in the UE-capability signaling, it means that it has two receive antennas (i.e., two receive chains) but only is capable of transmitting from one of those antennas at a time (i.e., one transmission chain) with support for antenna switching. In this case, two single-port SRS resources can be configured to the UE such that it can sound both receive ports using a single transmit port with an antenna switch in between.

Additional UE capabilities were introduced in NR Rel-16, where the IE supportedSRS-TxPortSwitch-r1610 can have values:
t1r1-t1r2,
t1r1-t1r2-t1r4,
t1r1-t1r2-t2r2-t2r4,
t1r1-t2r2,
t1r1-t2r2-t4r4,
t1r1-t1r2-t2r2-t1r4-t2r4.
   This IE can be used to indicate support for the UE to be configured with SRS resource set(s) with usage ‘antennaSwitching’ but where only a subset of all UE antennas is sounded. For example, the UE capability t1r1-t1r2 means that the gNB can configure one single-port SRS resource (same as no antenna-switching capability) or two single-port SRS resources (same as for the capability “t1r2” described above) with usage ‘antennaSwitching’ per SRS resource set. In this case, if the UE is configured with a single SRS resource (no antenna switching), it will only sound only one of its two antennas, which will save UE power consumption at the cost of reduced channel knowledge at the gNB (since the gNB can only estimate the channel between itself and the UE based on one of the two UE antennas).

For SRS resources with usage ‘antennaSwitching’ for a UE with fewer transmit chains than receive chains, a guard period has to be configured between SRS resources to account for Tx switching transient time. For subcarrier spacing below 120 kHz the guard period is 1 OFDM symbol, while for sub-carrier spacing of 120 KHz it is 2 OFDM symbols. This means that a UE is expected to be able to switch antenna within one or two OFDM symbols, depending on sub-carrier spacing.

### Multi-Beam Operation

### Beam Management Procedure

In high frequency range (FR2), multiple RF beams may be used to transmit and receive signals at a gNB and a UE. For each DL Tx beam from a gNB, there is typically an associated best UE Rx beam for receiving signals from the DL beam. The DL beam and the associated UE Rx beam form a beam pair. The beam pair can be identified through a so-called beam management process in NR.

A DL beam is (typically) identified by an associated DL reference signal (RS) transmitted in the beam, either periodically, semi-persistently, or aperiodically. The DL RS for the purpose can be a Synchronization Signal (SS) and Physical Broadcast Channel (PBCH) block (SSB) or a Channel State Information RS (CSI-RS). By measuring all the DL RSs, the UE can determine and report to the gNB the best DL beam to use for DL transmissions. The gNB can then transmit a burst of DL-RS in the reported best DL beam to let the UE evaluate candidate UE Rx beams.

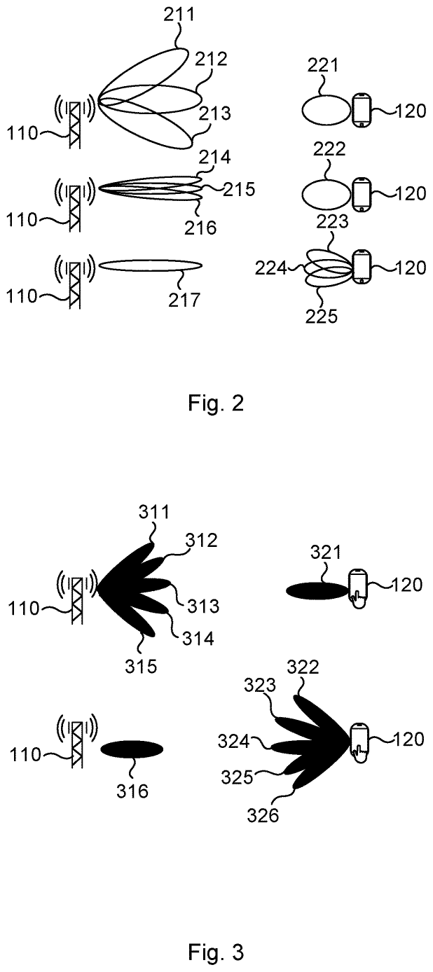

Although not explicitly stated in the NR specification, beam management has been divided into three procedures, schematically illustrated in FIG. 2:
P-1: Purpose is to find an approximate direction for the UE 120 using wide gNB Tx beams 211, 212, 213 from the gNB 110 covering the whole angular sector. The UE 120 can use a single Rx beam 221.
P-2: Purpose is to refine the gNB Tx beam by doing a new beam search around the coarse direction found in P-1, namely, by transmitting regular (narrow) Tx beams 214, 215, 216. The UE 120 can use a single Rx beam 222.
P-3: Used for UEs that have analog beamforming to let them find a suitable UE Rx beam. In P-3, the UE 120 receives on multiple beams 223, 224, 225 while the gNB 110 transmits on a constant beam 217, which is preferably a regular (narrow) beam.
P-1 is expected to utilize beams with rather large beamwidths and where the beam reference signals are transmitted periodically and are shared between all UEs of the cell. Typically reference signal to use for P-1 are periodic CSI-RS or SSB. The UE then reports the N best beams to the gNB and their corresponding RSRP values.
P-2 is expected to use aperiodic/or semi-persistent CSI-RS transmitted in narrow beams 214, 215, 216 around the coarse direction found in P-1.
P-3 is expected to use aperiodic or semi-persistent CSI-RSs repeatedly transmitted in one narrow gNB beam 217. One alternative way is to let the UE determine a suitable UE Rx beam based on the periodic SSB transmission. Since each SSB consists of four OFDM symbols, a maximum of four UE Rx beams 223, 224, 225 can be evaluated during each SSB burst transmission. One benefit with using SSB instead of CSI-RS is that no extra overhead of CSI-RS transmission is needed.

### Beam Indication

In NR, several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving a signal on the other antenna port. For example, there may be a QCL relation between a CSI-RS for tracking RS (TRS) and the PDSCH DMRS. When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in 3GPP NR to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its Rx beam in some direction prior to receiving a certain signal. If the UE knows that the signal is spatially QCL with some other signal it has received earlier, then it can safely use the same Rx beam to receive also this signal.

In NR, the spatial QCL relation for a DL or UL signal/channel can be indicated to the UE by using a “beam indication”. The “beam indication” is used to help the UE to find a suitable Rx beam for DL reception, and/or a suitable Tx beam for UL transmission. In NR, the “beam indication” for DL is conveyed to the UE by indicating a transmission configuration indicator (TCI) state to the UE, while in UL the “beam indication” can be conveyed by indicating a DL-RS or UL-RS as spatial relation (in NR Release 15/16) or a TCI state (in NR Release 17).

### UL Beam Management

Some UEs might have analog beamformers without beam correspondence or with poor beam correspondence (i.e. Tx/Rx correspondence), which implies that DL/UL reciprocity cannot always be used to determine the beams for these beamformers. For such UEs, the UE beam used for UL cannot be derived from beam management procedures based on DL reference signals as described above. To handle such UEs, UL beam management has been included in the NR standard specification since release 15. The main difference between normal beam management and UL beam management is that UL beam management utilizes uplink reference signals instead of DL reference signals. The UL reference signals that have been agreed to be used for UL beam management is sounding reference signals (SRS).

FIG. 3 schematically illustrates the two UL beam management procedures are supported in NR: U2 and U3. The U2 procedure (upper half) is performed by the UE 120 transmitting a burst of SRS resources in one UE Tx beam 321 and letting the gNB's TRP 110 evaluate different TRP Rx beams 311, 312, 313, 314, 315. The U3 procedure (lower half) lets the UE find a suitable UE Tx beam by transmitting different SRS resources in different UE Tx beams 322, 323, 324, 325, 326 while the TRP 110 maintains a constant beam 316.

UL beam management can also be useful even if UEs have beam correspondence. More precisely:
Some companies in 3GPP are arguing that a combined DL beam management procedure and UL beam management procedure requires less overhead and latency compared to only using DL beam management procedures.
So-called ‘Uplink-only’ node deployments are a hot topic in 3GPP to improve UL coverage in a cost-efficient way (especially at higher frequencies). An “UL only” network node is equipped with UL capability but with none or very limited downlink capability. In this case, since the “UL only” node is not capable of transmitting DL reference signals, the beam pair link between a UE and an “UL only” node has to be based on UL beam management procedures.
In D-MIMO, there will be many different access points (AP) or transmission points (TRPs) in a small area, and where each AP/TRP might be equipped with multiple different beams. In case DL-beam management is used to determine a suitable AP/TRP and corresponding AP/TRP beam to a UE, significant amount of reference signal overhead is need, which has been identified as an issue for D-MIMO. Hence, it has internally been suggested AP/TRP selection and corresponding beam selection should preferably be based on UL SRS transmission from the UE (which then could be used to determine suitable AP/TRP and corresponding AP/TRP beams for that UE).

Hence, it is likely that UL beam management will play a more significant role for 5G Advanced and 6G applications.

### UE Panels

For UEs, the signals can arrive and emanate from all different directions, which makes it is beneficial to have an antenna implementation at the UE which has the possibility to generate omni-directional-like coverage in addition to the high gain narrow beams. One way to increase the omni-directional coverage at a UE is to install multiple panels, and point (orient) these panels into different directions, which typically is the case for commercial UEs. However, in order to reduce the cost and energy consumption, some of these UEs can only transmit from one UE panel at each point in time.

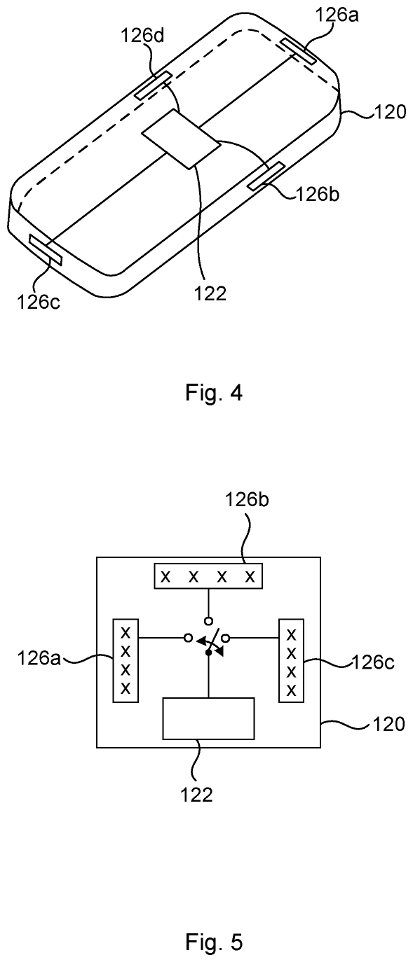

FIG. 4 illustrates one example of a realistic UE 120 with two baseband chains (one per polarization) 122 which are used to switch between four different dual-polarized panels 126. Each panel 126 is operable to transmit beams in directions typically corresponding to a half plane into the main transmit direction of the panel. More precisely, the antennas in one panel 126 may be oriented parallel to each other into a common direction. Oftentimes though not necessarily, the antennas in one panel 126 are physically close, e.g., the mutual distances of the antennas in one panel 126 are smaller than the distance to an antenna in any other panel. Further, the antennas in one panel 126 may be fed by an RF signal at a common input point, which can be connected and disconnected to the baseband chain 122 collectively.

FIG. 5 shows a wireless device 120 with three panels 126 oriented in orthogonal directions to improve spherical coverage. The wireless device has one baseband chain 122 at its disposal that can be connected to one of the panels 126 at a time. This ability is illustrated by an analog switch in FIG. 5. With reference to a similar UE structure, it is described in the presentation
Qualcomm Technologies, Breaking the Wireless Barriers to Mobilize 5G NR mmWave, May 2019, downloaded from https://www.qualcomm.com/content/dam/qcomm-martech/dm-assets/documents/breaking_the_wireless_barriers_to_mobilize_5g_nr_mmwave.pdf how antenna switching can be used to switch between three UE panel modules M1, M2, M3.

A UE panel of a commercial UE can generate beams of different beam widths, for instance:

TABLE 1

| | | Equivalent | |
|---|---|---|---|
| | Half-power | isotropically | |
| Beamforming | beam width | radiated power | Number of pointing |
| gain | (HPBW) | (EIRP) | directions |
| 0 dB | 90 degrees | 13 dBm | 1 beam |
| 3 dB | 90 degrees | 19 dBm | 5 beams |
| 9 dB | 30 degrees | 25 dBm | 9 beams |

Typically, commercial UEs generate the wider beams by temporarily deactivating one or multiple power amplifiers (PAs) of the panel, which has a negative impact on the available output power. However, it is possible to mitigate the output power loss when generating wide beams by applying dual-polarized beamforming, e.g., using array-size-invariant (ASI) beamforming. It is useful for the UE to generate a wide beam of a panel during beam sweep procedures to first find a coarse direction to a serving AP/TRP, which would enable the UE to select and activate a suitable UE panel. In the example of Table 1, the UE can generate one wide beam, five semi-wide (or half-wide) beams, and nine narrow beams for each panel.

### Beam Selection Method

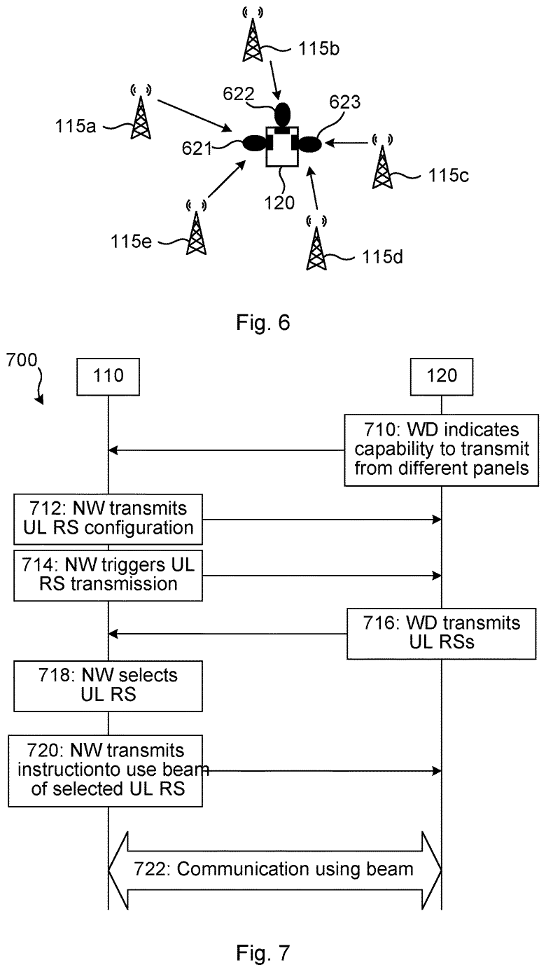

FIG. 6 illustrates a multi-TRP/D-MIMO mmWave deployment with five TRPs 115a, 115b, 115c, 115d, 115e. A mmWave wireless device (or UE) 120 with three panels is located in an intersection of coverage areas of the TRPs 115a, 115b, 115c, 115d, 115e. Each panel is operable to transmit beams 621, 622, 623 in directions typically corresponding to a half plane into the main transmit direction of each panel. Specifically, different UE panels are associated with different TRPs/APs 115.

To enable beam pair link selection between wireless device 120 and network, one option is to initially select a suitable combination of a TRP/AP 115 and a UE panel, and then perform a narrow beam sweep to determine a narrow beam for the determined UE panel and a narrow beam for the determined TRP/AP 115. It is assumed that the wireless device 120 can transmit UL-RSs in all different directions, e.g., by transmitting an UL-RS from all UE panels and where a wide beam 621, 622, 623 is used per UE panel. The other option is, instead of initially determining such a combination of a TRP/AP 115 and a UE panel, to directly transmit an SRS from each of the narrow beams over all UE panels; that would however introduce an unacceptable amount of SRS overhead signaling and latency. For example, assume that a wireless device 120 is equipped with 4 panels, and each panel has 9 narrow beams, then the wireless device 120 needs to sweep through 4×9=36 beams during each UL beam management procedure; because a simple wireless device 120 can usually only transmit from one beam from one panel at each time instance, this sweep would occupy no less than 36 OFDM symbols would be needed. In addition, in case the TRP/APs 115 need to perform TRP/AP beam sweeping procedures to determine a suitable TRP/AP beam for respective UE beam, each of the 36 SRS resources need to be repeated n times, where n is equal to the number of TRP/AP beams to be evaluated.

Reference is made to FIG. 7, which is a sequence diagram illustrating a method of determining a beam to be used for communication between a network node 110 and a wireless device 120. From the wireless device's 120 point of view, FIG. 7 provides a method for facilitating the determination of a beam to be used by the wireless device 120 for communication with the network node 110. From the network node's 110 perspective, FIG. 7 provides a method for determining a beam to be used by the wireless device 120 for communication with the wireless device 120; additionally the network node 110 may determine a beam for its own use in said communication. It is appreciated that the determined beam to be used by the wireless device 120 is transmitted from a specific one of the panels, that is, the panel from which the UL RS selected by the network node 110 was transmitted.

In an optional first step 710, the wireless device 120 indicates a capability to transmit from different panels 126. The indicated capability may relate, more precisely, to transmitting, during a beam management procedure, on different UL RS resources which are associated with (or transmitted from) at least two different UE panels 126.

The capability may be indicated by a further development of the capability signaling specified in 3GPP NR. More precisely, the capability that the wireless device signals may be referred to as a “UE panel switching capability”. In some embodiments, the indicated capability of the wireless device includes one or more of:
1. a number of panels;
2. a number of simultaneously transmitting panels;
3. a panel-switching gap period.

With regard to item 2, reference is made to FIG. 5, which shows a wireless device 120 with a single baseband chain 122, which is thus functionally limited to transmission from one panel 126 at a time. With regard to item 3, the panel-switching gap period may refer to a duration Ts such that two transmissions from different panels must not be scheduled closer to each other than Ts units of time. In other words, the first transmission must terminate at least Ts units before the second transmission is scheduled to begin. It is noted that the panel-switching gap period, unlike the panel-switching transient time to be introduced below, is a global quantity characterizing the wireless device 120 as a whole.

In some embodiments, the indicated capability of the wireless device includes, for each panel, one or more of:
1. radiated power per beam;
2. antenna gain per beam;
3. support for generating wide beams;
4. support for a first beam type with a single beam per panel;
5. support for generating semi-wide beams;
6. support for a second beam type with multiple beams per panel;
7. support for generating narrow beams;
8. a number of UL RS ports that the wireless device can transmit in one beam of a given type or a given width;
9. a number of supported beam types, each beam type associated with a different beam width;
10. a number of beams for a supported beam type;
11. an approximate beam width of a supported beam type;
12. a number of transmitter ports (i.e., antenna ports, transmitter antenna ports).

Examples of items 1, 10 and 11 were disclosed in Table 1. Items 10 and 12 express an important property of the wireless device 120, namely, since different ways exist of generating beams with different widths. In particular, if dual-polarized beamforming is utilized to generate a wide beam (beam type with a relatively large width) from a panel and the wireless device has an analog beamformer on that panel, then it is able to transmit UL RS from a single port at a time from this panel. With regard to items 4 and 6, a beam type may be characterized by its width (e.g., wide, semi-wide, narrow), and this can be useful for enabling hierarchic sweeping. With regard to item 6, it is not required that the panel shall be able to transmit said multiple beams simultaneously. With regard to item 12, a typical number of transmitter ports in a UE 120 is two.

The above embodiments may belong to a first subgroups of embodiments (without panel IDs) or a second subgroup of embodiments (with panel IDs). Some embodiments in the second subgroup of embodiments will be described next.

In embodiments within the second subgroup, the indicated capability of the wireless device includes a panel ID associated with one of the panels 126. In particular, each panel 126 of the wireless device 120 may carry a panel ID. Optionally, the indicated capability of the wireless device includes, for each panel ID, one or more of:
1. radiated power per beam;
2. antenna gain per beam;
3. support for generating wide beams;
4. support for a first beam type with a single beam;
5. support for generating semi-wide beams;
6. support for a second beam type with multiple beams;
7. support for generating narrow beams;
8. a number of UL RS ports that the wireless device can transmit in one beam of a given type or a given width;
9. a number of supported beam types, each beam type associated with a different beam width;
10. a number of beams for a supported beam type;
11. an approximate beam width of a supported beam type;
12. number of ports;
13. panel-switching transient time.
   Reference is made to the above explanations relating to these capabilities. With regard to item 13, the panel-switching transient time may be expressed as a start transient (time required to elapse before transmission from the panel with the panel ID is operative), as an end transient (time required to end an ongoing transmission from the panel with the panel ID), or the maximum of the start transient and end transient. This allows a total switching time between each two panels to be determined, which provides a precise criterion to be observed when the UL RS transmissions are configured. It is noted that the panel-switching transient time allows different transient times to be indicated for different panels in a single wireless device 120.

In one particular embodiment, “UE panel switching capability” can for example contain one or more of the following information: number of UE panels, maximum number of simultaneously transmitting UE panels, support of generating a wide beam per UE panel, support of generating semi-wide beams per UE panel, number of semi-wide beams per UE panel, number of narrow beams per UE panel, panel switching gap period, number of ports per UE panel, antenna gain per beam type (i.e. wide beam, semi-wide beam, and narrow beam) per UE panel etc. Optionally, the “UE panel switching capability” contains explicit UE panel IDs, and the information listed above can be signaled per UE panel ID.

In a further particular embodiment, the wireless device 120 reports whether the wireless device 120 is capable of performing dual-polarized beamforming (see S. O. Peterson, Power-Efficient Beam Pattem Synthesis via Dual Polarization Beamforming, arXiv: 1910.10015 [eess.SP], 22 Oct. 2019, and references therein) when generating a wide beam and/or semi-wide beams from one or more UE panels. If this capability is reported it is assumed that the same maximum output power is available when transmitting SRS from a UE panel for all different kind of UE panel beam widths (beam types). If the network knows the output power difference between different beam types during an SRS antenna switching procedure, the network can more easily determine if further beam refinement is needed or if the link budget is good enough based on the performed antenna switching procedure. This information could also be combined with for example antenna gain per beam types.

In one particular embodiment, the wireless device reports antenna gain and/or output power per beam type for one or more UE antenna panels. If the network knows the output power difference between different beam types as well as the antenna gain differences, the network can more easily determine whether further beam refinement is needed or the link budget is good enough based on the performed antenna switching procedure.

In one further particular embodiment, the wireless device reports the EIRP for respective beam type for one or more UE panels. In this way, the network can more easily determine whether further beam refinement is needed or if the link budget is good enough based on the performed antenna switching procedure.

In a second step 712, the network node 110 transmits a UL RS configuration to the wireless device 120. For example, one or more UL RS resources can be transmitted (or associated) per UE panel using a certain beam type (e.g., one wide beam per UE panel). Here, each UL RS resource can consist of one or two UL RS ports. In case two UL RS ports per UL RS resource are used, each UL RS port is typically transmitted from one out of two polarizations of the UE panel.

In some embodiments, the (information in the) UL RS configuration is grouped into UL RS resource sets, each UL RS resource set being associated with a different panel of the wireless device 120.

In particular, the number of UL RS resource sets may be equal to the number of panels according to the indicated capability of the wireless device. This corresponds to configuring reference signals for the full range of panels of the wireless device 120. Optionally, the UL RS configuration specifies a gap period between consecutive UL RS resource sets, said gap period corresponding to the panel-switching gap period according to the indicated capability of the wireless device.

Alternatively, the UL RS configuration consists of a single UL RS resource set with multiple UL RS resources, and each of said UL RS resources is associated with a different panel. It is appreciated that the UL RS configuration may optionally specify a gap period between consecutive ones of the UL RS resources, and the gap period may correspond to the panel-switching gap period according to the indicated capability of the wireless device.

In some embodiments, the UL RS configuration includes an explicit indication of a beam width or a beam type with uniform width to use when transmitting an UL RS resource from a panel. This is to say, the UL RS configuration may indicate a nominal width or a range of nominal widths of the beam (e.g., in terms of HPBW). Alternatively, the UL RS configuration may refer to one of a number of pre-agreed beam types which differ with respect to their widths, e.g. on a scale from ‘wide’ to ‘narrow’, wherein it is up to implementers to specify the actual widths of these beam types in physical units.

In some embodiments, the UL RS configuration includes an implicit indication of a beam width or a beam type with uniform width to use when transmitting an UL RS resource from a panel. For instance, the (relative) beam width can be inferred from the number of UL RS resources or beams.

Within these embodiments, it may be assumed that the UL RS configuration is grouped into UL RS resource sets. Then, the implicit indication is to use, for a panel, a beam width or beam type which the panel supports according to the indicated capability of the wireless device, and which has a number of beams equal to the number of configured UL RSs in an UL RS resource set for the panel. Indeed, if the wireless device 120 has indicated in step 710 that it supports N₁ beams of Beam Type 1, N₂ beams of Beam Type 2 and N₃ beams of Beam Type 3, and a UL-RS resource set is configured in step 712 with N₂ UL RS resources, then the network expects the wireless device 120 to use Beam Type 2 when transmitting the UL-RS resources. Here, assuming N₁<N₂<N₃, the three beam types may have gradually ascending nominal widths.

In first example of the implicit indication, if there is a single configured UL RS in an UL RS resource set for a panel, on the one hand, and an indicated capability to generate wide beams from the panel, on the other hand, then the wireless device 120 may infer that it shall apply a wide beam when transmitting said UL RS.

In a second example of the implicit indication, if there are a number (greater than or equal to 2) of configured UL RS resources in an UL RS resource set for a panel, on the one hand, and an indicated capability to generate an equal number of semi-wide beams from the panel, on the other hand, then the wireless device 120 may infer it shall apply a semi-wide beam when transmitting each of said UL RSs.

In a third example of the implicit indication, if there is a single configured UL RS resource set with a plurality of UL RSs associated with different panels, on the one hand, and an indicated capability to generate wide beams from said panels, on the other hand, then the wireless device 120 may infer it shall apply a wide beam when transmitting each of said UL RSs. Optionally, the number of UL RSs in the single configured UL RS resource set is equal to the number of panels according to the indicated capability.

In some embodiments, the UL RS configuration includes an UL RS resource associated with a repetition factor. The repetition factor signifies that the wireless device 120 shall transmit in the UL RS resource for multiple consecutive OFDM symbols.

In some embodiments, the UL RS configuration includes a sounding reference signal (SRS) resource. This SRS resource or resources may be contained in an SRS resource set with an indicated usage representing panel switching. With respect to the RRC protocol in 3GPP NR, the usage may be assigned the value ‘antennaSwitching’ or ‘beamManagement’. Alternatively, the usage representing panel switching can be a new value that presently is not defined in the RRC protocol, such as ‘panelSwitching’.

If the optional first step 710 has been performed, the UL RS configuration may be based on the received “UE panel switching capability”. The UE panel switching configuration can for example be a set of UL RSs, that is configured according to the “UE panel switching capability”.

Within the second subgroup of embodiments, where the indicated capability of the wireless device includes a panel ID associated with one of the panels 126, the UL RS configuration may explicitly indicate a panel ID. The panel ID may be indicated for each UL RS resource. Specifically, the UL RS configuration may be grouped into UL RS resource sets, and each UL RS resource set is associated with a different panel ID. The panel ID may refer to the panel to be used for transmitting in these UL RS resources. Alternatively, the UL RS configuration consists of a single UL RS resource set with multiple UL RS resources, and each UL RS resource is associated with a different panel ID.

In one particular embodiment, each UL-RS is explicitly associated with a previously reported UE panel ID, such that the wireless device knows which UL-RS should be transmitted from which UE panel. In one detailed embodiment for NR, the wireless device is configured with N SRS resource sets, where N is equal to the number of UE panels, and where each SRS resource consists of M SRS resources, where M is equal to the number of UE beams that should be evaluated per UE panel. In addition, each SRS resource can consist of one or two SRS ports (i.e., transmitter antenna ports) depending on the number of Tx chains of respective UE panel. In one related particular embodiment, the number of SRS resource sets that the wireless device can transmit simultaneously (i.e., the number of SRS resource sets that contains SRS resources that are timewise overlapping with each other) is based on the maximum number of simultaneously transmitting UE panels indicated in “UE panel switching capability”.

In a third step 714 of the method 700, the transmission of the UL RS is triggered. The triggering may be initiated actively by the network node 110, or it may be a consequence of the UL RS configuration, of scheduling or the like.

In a fourth step 716, the wireless device 120 transmits the UL RSs as triggered.

In one particular embodiment, the wireless device 120 is configured to transmit one UL RS per UE panel using a wide beam per UE panel, which could be used to determine a suitable combination of a UE panel 126 and a TRP/AP 115.

In one particular embodiment, the wireless device is configured with multiple UL RSs from each UE panel, where the multiple UL-RSs are transmitted with the same wide beam. In this way the network can sweep through different TRP/AP Rx beams during the UL-RS transmission, and in addition to determining said combination of a UE panel and a TRP/AP 115, a suitable TRP/AP beam can be determined as well.

In one particular embodiment, the wireless device is configured with multiple UL RSs for each UE panel, where the multiple UL RS are transmitted in different semi-wide or narrow beams of one or more UE panels. In this way, it is possible to determine both which UE panel should be used, and which beam to apply for that UE panel.

In one particular embodiment, the wireless device should transmit all the SRSs from all different panels (i.e., for all SRS used in a panel switching procedure) with equal output power. In this way, it is easier for the network to compare different beam pair links between the wireless device and the network and in this way determine the best beam pair link. In NR, the UL output power control is configured per SRS resource set and the determined UL output power might therefore become different for different UE panels (assuming different SRS resource sets are used for different UE panels). To mitigate this issue, in one embodiment, if the UL power control results in different UL output power for different SRS resource sets of a panel switching procedure, the wireless device should override the configured UL power control and set the output power equally for each UE panel. More precisely, the wireless device could for example select an UL output power corresponding to the UE panel with highest output power and apply that for all the UE panels during the panel switching procedure, or it could determine an average output power based on all the power control loops.

In a fifth step 718, the network node 110 selects one UL RS out of the received UL RSs. The selection can be based on any suitable evaluation criterion. Further, a trained ML model may be used, as described in more detail below.

In some embodiments, step 718 includes selecting two of the received UL RSs, which form a beam pair to be used for the subsequent communication between the wireless device 120 and network node 110.

It is understood that the network node 110 can receive the UL RSs at one or multiple APs/TRPs 115, allowing it to determine:
a preferred TRP/AP (for each wireless device or each UE panel),
a preferred beam for the preferred TRP/AP (for each wireless device or each UE panel),
a preferred UE panel, and/or
a preferred UE panel beam.

In a sixth step 720, the network node 110 communicates its selection to the wireless device 120 in the form of an instruction for the wireless device 120 to communicate with the network node 110 using beams corresponding to the selected one or more UL RSs. For example, the instruction may refer to one beam from a first panel and another beam from a second panel.

It is also possible for further beam management procedures to be executed during this step 720. For example, if a suitable combination of a UE panel and a TRP/AP 115 has been determined in step 720, further beam management procedures might be triggered to determine which beam to use for the selected TRP/AP 115 or to determine which beam to use for the selected UE panel, or both.

In a seventh step 722, the network node 110 and wireless device 120 communicate by uplink and/or downlink transmissions of data and signaling using said beams corresponding to the selected one or more UL RSs.

### ML-Based Beam Prediction

To facilitate the AI/ML-based beam prediction, it is generally beneficial to accumulate as much information as possible—and as diverse information as possible—at the gNB. This includes information used for initially training the AI/ML model as well as information to be fed during operation to the trained model to obtain a decision.

To respond to this need, the present disclosure further relates a method for training a ML model, which comprises: transmitting to a wireless device 120 an UL RS configuration indicating at least two UL RS resources to be transmitted from different panels 126, each panel representing a group of related transmit antennas; receiving at a network node 110 a plurality of UL RSs from the wireless device in accordance with the UL RS configuration; and providing training data on the basis of measurements on the received UL RSs. Optionally, the training data can further include a ground-truth selection of one of the received UL RSs which represents at least one beam suitable for communication between the network node 110 and the wireless device 120, wherein possibly the beam or beams have been successfully used for such communication.

Still further, the present disclosure relates a method for applying a ML model for beam selection, which comprises: transmitting to a wireless device 120 an UL RS configuration indicating at least two UL RS resources to be transmitted from different panels 126, each panel representing a group of related transmit antennas; receiving at a network node 110 a plurality of UL RSs from the wireless device in accordance with the UL RS configuration; and providing decision data, on the basis of measurements on the received UL RSs, to a trained ML model; obtaining a beam selection decision from the ML model; and transmitting an instruction for the wireless device 120 to communicate with the network using beams corresponding to the selected one or more UL RSs.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1-32. (canceled)

33. A method in a wireless device for facilitating the determination of a beam to be used for communication with a network, the method comprising:
indicating to the network a capability to transmit from different panels, wherein the indicated capability of the wireless device includes a number of simultaneously transmitting panels, each panel representing a group of related transmit antennas;
receiving from the network an uplink reference signal, UL RS, configuration indicating at least two UL RS resources to be transmitted from different panels;
transmitting a plurality of UL RSs using the different panels in accordance with the UL RS configuration; and
receiving an instruction to communicate with the network using one or more beams, each beam corresponding to one of the transmitted UL RSs.

34. The method of claim 33, wherein the indicated capability of the wireless device further includes one or more of:
a number of panels;
a panel-switching gap period.

35. The method of claim 33, wherein the indicated capability of the wireless device includes, for each panel, one or more of:
radiated power per beam;
antenna gain per beam;
support for generating wide beams; support for a first beam type with a single beam;
support for generating semi-wide beams;
support for a second beam type with multiple beams;
support for generating narrow beams;
a number of UL RS ports that the wireless device can transmit in one beam of a given type or a given width;
a number of supported beam types, each beam type associated with a different beam width;
a number of beams for a supported beam type;
an approximate beam width of a supported beam type;
a number of transmitter ports.

36. The method of claim 33, wherein the UL RS configuration is grouped into UL RS resource sets, each UL RS resource set being associated with a different panel.

37. The method of claim 36, wherein the number of UL RS resource sets is equal to the number of panels according to the indicated capability of the wireless device.

38. The method of claim 36, wherein the UL RS configuration specifies a gap period between consecutive UL RS resource sets, said gap period corresponding to the panel-switching gap period according to the indicated capability of the wireless device.

39. The method of claim 33, wherein the UL RS configuration consists of a single UL RS resource set with multiple UL RS resources, each UL RS resource being associated with a different panel.

40. The method of claim 33, wherein the UL RS configuration includes an explicit indication of a beam width or a beam type with uniform width to use when transmitting an UL RS resource from a panel.

41. The method of claim 33, wherein the UL RS configuration includes an implicit indication of a beam width or a beam type with uniform width to use when transmitting an UL RS resource from a panel.

42. The method of claim 41, wherein:
the UL RS configuration is grouped into UL RS resource sets; and
the implicit indication is to use, for a panel, a beam width or beam type which the panel supports according to the indicated capability of the wireless device, and which has a number of beams equal to the number of configured UL RSs in an UL RS resource set for the panel.

43. The method of claim 42, wherein the combination of a single configured UL RS in an UL RS resource set for a panel, on the one hand, and an indicated capability to generate wide beams from the panel, on the other hand, signifies that the wireless device shall apply a wide beam when transmitting said UL RS.

44. The method of claim 42, wherein the combination of a number of configured UL RS resources in an UL RS resource set for a panel, on the one hand, and an indicated capability to generate an equal number of semi-wide beams from the panel, on the other hand, signifies that the wireless device shall apply a semi-wide beam when transmitting each of said UL RSs.

45. The method of claim 44, wherein the combination of a single configured UL RS resource set with a plurality of UL RSs associated with different panels, on the one hand, and an indicated capability to generate wide beams from said panels, on the other hand, signifies that the wireless device shall apply a wide beam when transmitting each of said UL RSs.

46. The method of claim 45, wherein the number of UL RSs in the single configured UL RS resource set is equal to the number of panels according to the indicated capability.

47. The method of claim 33, wherein the UL RS configuration further includes an UL RS resource associated with a repetition factor signifying that the wireless device shall transmit in the UL RS resource for multiple consecutive symbols.

48. The method of claim 33, wherein the UL RS configuration includes a sounding reference signal, SRS, resource.

49. The method of claim 33, wherein
the UL RS configuration explicitly indicates, for each UL RS resource, a panel ID, and
the indicated capability of the wireless device includes a panel ID.

50. The method of claim 33, wherein
the UL RS configuration explicitly indicates, for each UL RS resource, a panel ID, and
the indicated capability of the wireless device includes, for each panel ID, one or more of:
radiated power per beam;
antenna gain per beam;
support for generating wide beams;
support for a first beam type with a single beam;
support for generating semi-wide beams;
support for a second beam type with multiple beams;
support for generating narrow beams;
a number of UL RS ports that the wireless device can transmit in one beam of a given type or a given width;
a number of supported beam types, each beam type associated with a different beam width;
a number of beams for a supported beam type;
an approximate beam width of a supported beam type;
number of ports;
panel-switching transient time.

51. The method of claim 33, wherein
the UL RS configuration explicitly indicates, for each UL RS resource, a panel ID, and
the UL RS configuration is grouped into UL RS resource sets, each UL RS resource set being associated with a different panel ID.

52. The method of claim 33, wherein
the UL RS configuration explicitly indicates, for each UL RS resource, a panel ID, and
the UL RS configuration consists of a single UL RS resource set with multiple UL RS resources, each UL RS resource being associated with a different panel ID.

53. A non-transitory computer readable storage medium storing a computer program comprising instructions for configuring a wireless device to perform the method of claim 33.

54. A method in a network node for determining a beam to be used for communication with a wireless device, the method comprising:
obtaining an indicated capability of the wireless device to transmit from different panels, wherein the indicated capability of the wireless device includes a number of simultaneously transmitting panels, each panel representing a group of related transmit antennas;
transmitting to the wireless device an uplink reference signal, UL RS, configuration indicating at least two UL RS resources to be transmitted from different panels;
receiving a plurality of UL RSs from the wireless device in accordance with the UL RS configuration;
selecting one or more of the received UL RSs; and
transmitting an instruction for the wireless device to communicate with the network using beams corresponding to the selected one or more UL RSs.

55. The method of claim 54, wherein:
at least two of the received UL RSs are selected, which form a beam pair,
the transmitted instruction is for the wireless device to communicate with the network using the beam pair.

56. A non-transitory computer readable storage medium storing a computer program comprising instructions for configuring a network node to perform the method of claim 54.

57. A wireless device for facilitating the determination of a beam to be used for communication with a network, the wireless device comprising processing circuitry configured to:
indicate to the network a capability to transmit from different panels, wherein the indicated capability of the wireless device includes a number of simultaneously transmitting panels, each panel representing a group of related transmit antennas;
receive from the network an uplink reference signal, UL RS, configuration indicating at least two UL RS resources to be transmitted from different panels;
transmit a plurality of UL RSs using the different panels in accordance with the UL RS configuration; and
receive an instruction to communicate with the network using one or more beams, each beam corresponding to one of the transmitted UL RSs.

58. A network node for determining a beam to be used for communication with a wireless device, the network node comprising processing circuitry configured to:
obtain an indicated capability of the wireless device to transmit from different panels, wherein the indicated capability of the wireless device includes a number of simultaneously transmitting panels;
transmit to the wireless device an uplink reference signal, UL RS, configuration indicating at least two UL RS resources to be transmitted from different panels;
receive a plurality of UL RSs from the wireless device in accordance with the UL RS configuration;
select one or more of the received UL RSs; and
transmit an instruction for the wireless device to communicate with the network using beams corresponding to the selected one or more UL RSs.
